(19) United States
(12) Patent Application Publication
(10) Pub. No.: US 2009/0171848 A1
(43) Pub. Date: Jul. 2, 2009

(54) MAILING MACHINE HAVING DYNAMICALLY CONFIGURABLE POSTAL SECURITY DEVICE TO SUPPORT MULTIPLE CUSTOMERS AND CARRIERS

(75) Inventors: John S. Wronski, JR., Shelton, CT (US); Catherine C. Morrissey, Woodbridge, CT (US); Robert W. Sisson, Trumbull, CT (US); Maria Paz Parkos, Southbury, CT (US)

Correspondence Address: PITNEY BOWES INC., 35 WATERVIEW DRIVE, MSC 26-22, SHELTON, CT, 06484-3000, US

(73) Assignee: Pitney Bowes Inc., Stamford, CT (US)

(21) Appl. No.: 11/966,099

(22) Filed: Dec. 28, 2007

(51) Int. Cl. G06Q 50/00; G06F 17/40

(52) U.S. Cl. 705/60

(57) ABSTRACT

A mail processing system having a postal security device (PSD) that can be dynamically configured to support multiple customers and carriers is provided. Meter records are maintained at a data center. Each meter record includes information necessary to configure the PSD for a particular customer and/or a specified carrier. The data center provides a requested meter record to the PSD, which then is configured according to the meter record. Once loaded with a complete meter record, the PSD will function as a traditional PSD and mail processing can be performed by the mail processing system using the configured PSD. All accounting takes place locally in the PSD, and all records maintained in the meter record are updated locally in the PSD. Upon completion of the mail run, the updated meter record can then be uploaded to the data center until the next mail run that requires the meter record.

### FIELD OF THE INVENTION

The invention disclosed herein relates generally to mailing systems, and more particularly to mailing systems that utilize configurable postal security devices to support multiple customers and carriers.

### BACKGROUND OF THE INVENTION

Mailing systems, such as, for example, a mailing machine, often include different modules that automate the processes of producing articles, such as, for example, mail pieces. Mail pieces can include, for example, envelopes, post cards, flats, and the like. The typical mailing machine includes a variety of different modules or sub-systems each of which performs a different task on the mail piece. The mail piece is conveyed downstream utilizing a transport mechanism, such as rollers or a belt, to each of the modules. Such modules could include, for example, a separating module, i.e., separating a stack of mail pieces such that the mail pieces are conveyed one at a time along the transport path, a moistening/sealing module, i.e., wetting and closing the glued flap of an envelope, a weighing module, and a metering/printing module, i.e., applying evidence of postage to the mail piece. The exact configuration of the mailing machine is, of course, particular to the needs of the user.

Typically, a control device, such as, for example, a microprocessor, performs user interface and controller functions for the mail processing system. Specifically, the control device provides all user interfaces, executes control of the mail processing system and print operations, calculates postage for debit based upon rate tables, provides the conduit for the Postal Security Device (PSD) to transfer postage indicia to the printer, operates with peripherals for accounting, printing and weighing, and conducts communications with a data center for postage funds refill, software download, rates download, and market-oriented data capture. The control device, in conjunction with an embedded PSD, constitutes the system meter that satisfies U.S. information-based indicia postage meter requirements and other international postal regulations regarding closed system meters.

In conventional mail processing systems, the PSD is configured for a specific application at time of initialization. This typically happens at a stage late in the manufacturing process. Once configured, the PSD is locked into that specific configuration throughout its life. Being locked into a specific configuration limits the potential uses of the mail processing system. In situations where it may be desired to support multiple carriers and customers, such as for example, in a mailhouse environment or a shared mail processing system environment, it would be necessary to utilize multiple mail processing systems.

It would be desirable, therefore, for a single mail processing system to be able to securely support multiple customers and carriers.

### SUMMARY OF THE INVENTION

The present invention alleviates the problems associated with the prior art and provides a system and method for allowing a single mail processing system to support multiple customers and carriers.

In accordance with the present invention, a mail processing system is provided with a PSD that can be dynamically configured. Meter records are maintained at a data center. Each meter record includes information necessary to configure the PSD for a particular customer and/or a specified carrier. When it is desired to process mail for a specific customer and carrier, the PSD communicates with the data center to request the appropriate meter record. The data center provides the requested meter record to the PSD, which then is configured according to the meter record. Once loaded with a complete meter record, the PSD will function as a traditional PSD and mail processing can be performed by the mail processing system using the configured PSD. All accounting takes place locally in the PSD, and all records maintained in the meter record are updated locally in the PSD. Upon completion of the mail run, the updated meter record can then be uploaded to the data center until the next mail run that requires the meter record. In this manner, a generic PSD is provided in which the number of customers and carriers that can be supported is flexible and updatable.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 illustrates a mail processing system with a generic PSD according to an embodiment of the present invention; and

FIGS. 2A and 2B illustrate in flow chart form an example of the processing performed by the mail processing system illustrated in FIG. 1.

### DETAILED DESCRIPTION OF THE PRESENT INVENTION

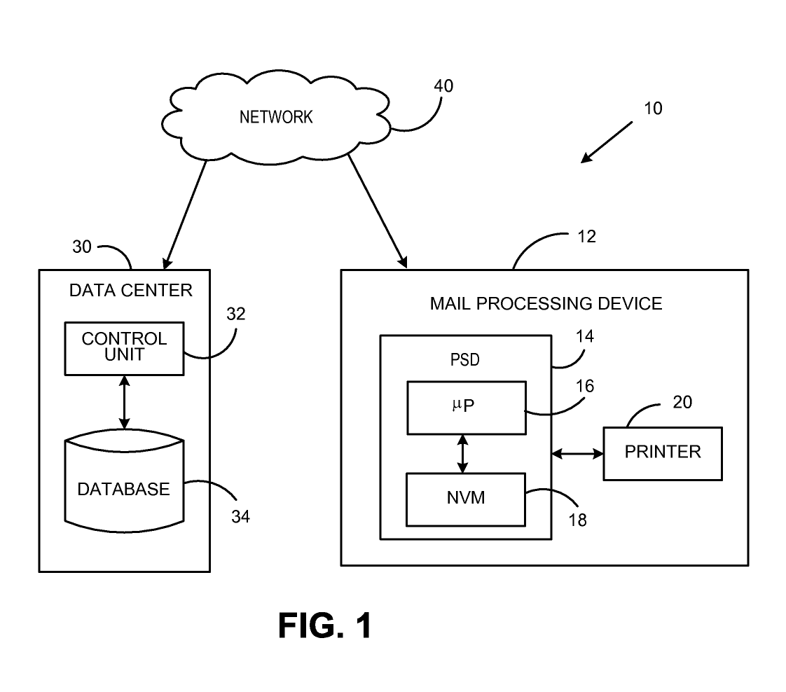

In describing the present invention, reference is made to the drawings, wherein there is seen in FIG. 1 a mail processing system 10 that operates according to an embodiment of the present invention. Mail processing system 10 includes a mail processing device 12, such as, for example, a mailing machine, inserter system or the like that is used to process mail pieces and print indicia on mail pieces to provide evidence of payment of postage. While only a single device 12 is illustrated, it should be understood that more than one device may be provided. Device 12 includes a printer 20, and a postal security device (PSD) 14 having a microprocessor 16 and a non-volatile memory 18. Microprocessor 16 is utilized to control functionality of the PSD 14, including, for example, performing cryptographic operations required to generate indicia. NVM 18 is adapted to store information required for the microprocessor 16 to operate. Printer 20 is utilized to print indicia generated by the PSD 14.

System 10 further includes a data center 30 having a control unit 32 and database 34. Control unit 32 can be, for example, a processing unit or the like that is adapted to control operation of the data center 30. Device 12 is adapted to communicate with the data center 30 via a network 40, such as, for example the Internet or the like.

Unlike a conventional postal security device, PSD 14 is not locked into a single configuration, and can not be used to generate any type of indicia without having a required meter record (described below) installed. The NVM 18 is used to store certain information associated with the PSD 14, including, for example, an identification number (serial number or the like) of the PSD 14, and one or more cryptographic keys that are utilized to secure communications with the data center 30 as described further below. NVM 18 is also utilized to maintain current information associated with each meter record previously downloaded to the PSD 14, which can include, for example, an upload count for each meter record, and one or more register values (from the last time the meter record was downloaded to PSD 14) for each meter record to prevent a replay of meter records (as described further below).

Database 34 of data center 30 is used to store meter records that are utilized to configure the PSD 14 when downloaded to the PSD 14. Each meter record is associated with a specific customer and includes information that enables the PSD 14 to generate indicia for the specific customer and/or carrier. Thus, a separate meter record will exist for each possible customer, and for each customer/carrier combination, for which indicia is authorized to be generated using the mail processing device 12. The meter record can include, for example, the following information: an identification number, a current upload count, one or more cryptographic keys required to generate indicia or ensure print security, a plurality of register values associated with accounting, serial number count for generated indicia, a postal code for the meter record, and any additional parameters required for the generation and accounting of indicia that may be required, including carrier specific requirements. The meter record identification number is associated with a particular customer, and provides a suitable identification of the meter record to allow the appropriate meter record to be downloaded upon request. The register values can include, for example, an ascending register value (value of all postage ever expended), a descending register value (value of postage remaining in meter record), a piece count, and any other register values associated with the meter record that are desired to be maintained.

Database 34 can also be used to store indicia records, which contain the information necessary to create an indicia as may be required by different carriers. Such information could include, for example, any necessary graphics, format information, etc. as specified by a carrier. Each meter record preferably includes an indicator that specifies the necessary indicia record that is to be utilized with the meter record.

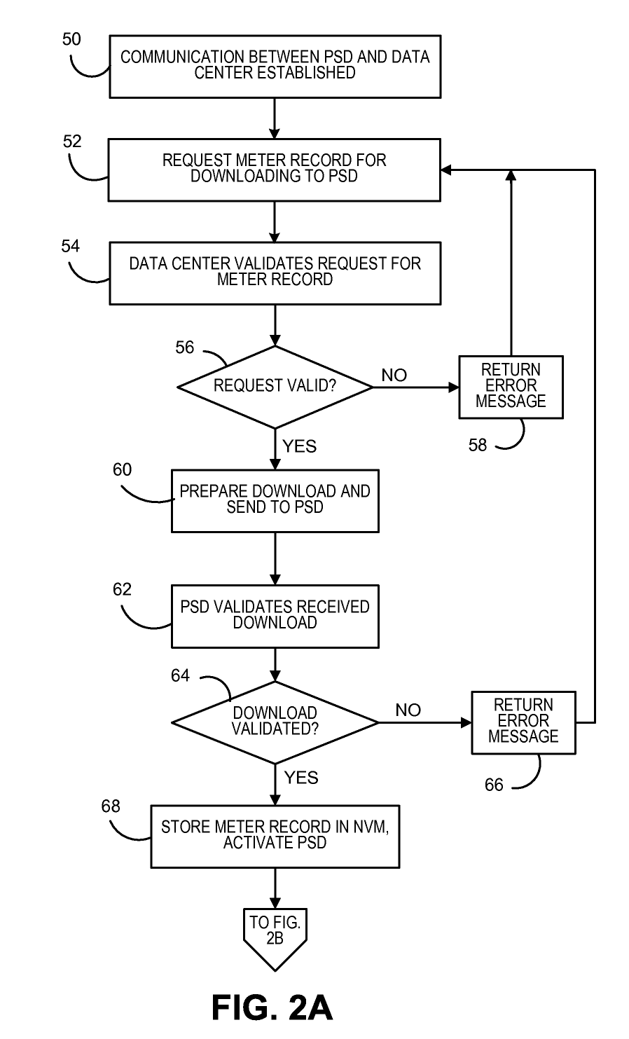

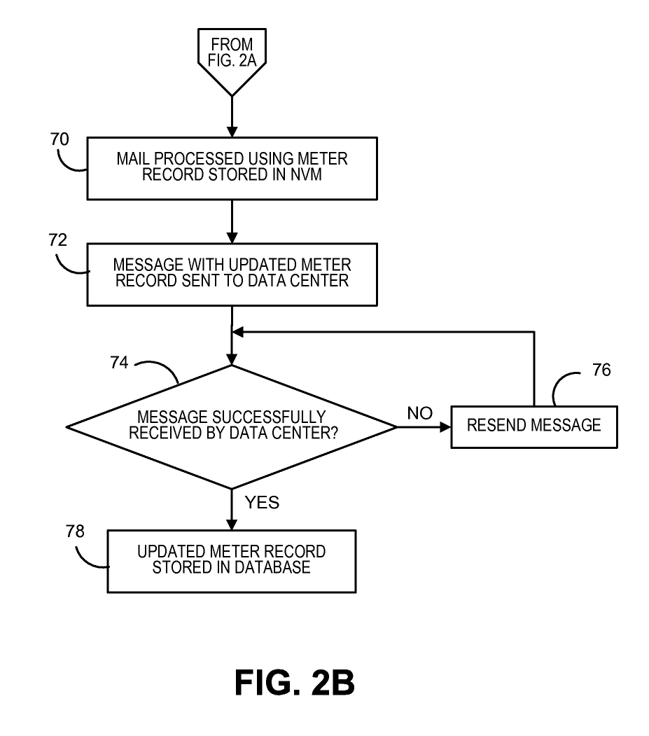

FIGS. 2A and 2B illustrate in flow diagram form the processing performed by the system 10 when the device 12 will be used to process mail pieces including generating indicia for the mail pieces. As previously noted, the PSD 14 is unable to generate any type of indicia without having a meter record installed. Thus, when it is desired to use the device 12 to generate indicia, it is necessary to download a suitable meter record from the data center 30 the PSD 14 of device 12. In step 50, a communication is established between the PSD 14 and the data center 30 via the network 40. Preferably, the PSD 14 and data center 30 perform an authentication procedure utilizing digital signatures or the like based on the cryptographic key(s) stored in the NVM 18 and symmetric key(s) stored in the database 34 of data center 30. In step 52, the user of the device 12 requests a specific meter record to be downloaded to the PSD 14. To prevent misuse of meter records, security such as password security can be utilized which allows a user to select only those meter records that are associated with a specific password input by the user. Thus, each user can have access only to specified meter records and will be unable to utilize any other meter records. To provide security for the system 10 and to prevent replay of old meter records, such a request preferably includes the meter record identification, and the current value of the upload counter for the requested meter record and the current value of the one or more register values for the meter record that are stored in the NVM 18 of PSD 14. The request can also include a digital signature or the like for authentication purposes.

In step 54, the control unit 32 of the data center 30 validates the request for the specified meter record based on the meter record stored in the database 34. This can include, for example, verifying the digital signature included with the request, ensuring that a corresponding meter record for the identification included in the request exists, and validating the register values included in the request with the register values included in the meter record from the database 34. The upload counter maintains a count of the number of times the meter record was previously uploaded by the PSD 14, and gets incremented each time the meter record is uploaded. Thus, if the upload counter included in the request does not match the upload counter included in the meter record stored in the database 34, this indicates that there is a discrepancy that needs to be resolved before the meter record can be utilized. For example, if the upload counter included in the request is less than the upload counter for the meter record as stored in the database 34, this can indicate that the request is an old request message that is improperly being resent. Additional security can be provided using the register value or values included in the request. The register value can be, for example, the ascending register value for the requested meter record, or a piece count for the meter record. As each meter record is utilized by the PSD 14 (as described below), the register values are updated and the final values for each session are preferably stored by the NVM 18. These values are included in the next request for the meter record, and can be used by the control unit 32 to ensure that the register values coincide with those as stored in the database 34. This provides security against tampering with the meter records, or attempting to fraudulently use the PSD 14 to generate indicia without properly accounting for the indicia in a meter record.

In step 56, it is determined if the request is a valid request as described above. If the request is not valid, then in step 58 an error message is returned which alerts the user that the request message was invalid. Optionally, processing can return to step 52 to allow the user to retry the request or make a new request. If it is determined in step 56 that the request is a valid request, then in step 60 the control unit 32 prepares a download to be sent to the PSD 14 and sends it to the PSD 14. Such a download includes the requested meter record retrieved from the database 34, and an updated upload count record for the meter record. The download can also optionally include an appropriate indicia record if required. Preferably, the download includes a digital signature that can be verified by the microprocessor 16 of the PSD 14 for added security.

In step 62, the microprocessor 16 of PSD 14 validates the received download. Such validation can include verifying the digital signature provided with the download, and also verifying that the updated upload count included with the download corresponds to the expected value, i.e., is equivalent to the next count in the sequence of the upload count as stored in the NVM 18, for the meter record. Such validation of the upload count ensures that the meter record being downloaded is fresh and is not a replay of an old meter record. In step 64 it is determined if the download has successfully been validated. If not, then in step 66 an error message is returned to the data center 30 and optionally, processing can return to step 52 to allow the user to retry the request or make a new request. If in step 64 it is determined that the download has been verified, the in step 68 the microprocessor 16 temporarily stores the meter record in the NVM 18 of PSD 14, increments the upload counter in the NVM 18 for the meter record, and activates the PSD 14 for use to generate indicia. The communication link between the data center 30 and PSD 14 may or may not be terminated depending upon the design of the system 10.

In step 70 (FIG. 2B), the mail processing device 12 can be used to process mail pieces using the meter record stored in the NVM 18. The generation of indicia and all accounting for each indicia generated are performed locally by PSD 14 using the meter record stored in the NVM 18, i.e., the cryptographic keys, the postal code, and other parameters provided in the meter record. Additionally, all records maintained in the meter record (e.g., register values) stored in the NVM 18 are updated only in the NVM 18 during the processing of the mail. Thus, all processing of the mail is performed by the device 12 without having to communicate with the data center 30. Upon completion of the processing of the mail using the meter record stored in NVM 18, then in step 72 the microprocessor 16 of PSD 14 generates a new message, including the updated meter record, which now reflects the mail that has been processed, and sends the message to the data center 30. If the communication between the data center 30 and PSD 14 was previously terminated, a new communication link would need to be established. In addition, in step 72 the current values of one or more registers, e.g., ascending register value or piece count register value, is stored in the NVM 18 associated with the meter record for use when the meter record is next requested to be downloaded from the data center 30. Optionally, the updated meter record can be maintained in the PSD 14 until a new meter record is requested to be downloaded. Upon request of a new meter record, the processing performed starting with step 72 will be initiated and the updated meter record sent to the data center 30.

Preferably, once the message for the data center has been prepared by the microprocessor 16, the meter record stored in the NVM 18 is removed by the microprocessor 16, thereby preventing the meter record from being subsequently used again by the PSD 14 without repeating the download process. This renders the PSD 14 inactive and unable to generate any indicia, as there is no longer any meter record for the PSD 14 to use. Preferably, in step 74 it is determined if the message with the updated meter record was properly received by the data center 30, such as, for example, by receipt of a confirmation message from the data center 30. If not, then in step 76 the message is resent from the PSD 14 to the data center 30 until the message is properly received. This prevents the updated meter record from being lost or damaged during transmission, and the possible corruption of the entire meter record if the updated values are never properly received at the data center 30. Upon successful receipt of the message by the data center, then in step 78 the updated meter record received from the PSD 14 is stored in the database 34 at the data center 30 for subsequent use.

The PSD 14, having removed the meter record, is now ready to request a new meter record associated with a different customer or carrier. Thus, according to the present invention, a single mail processing system having the capability to support multiple customers and carriers is provided by dynamically configuring the PSD with a meter record for each customer. Since all indicia generating and accounting is performed locally by the PSD using the installed meter record, it is not necessary for the mail processing system to be continuously connected to a data center. While preferred embodiments of the invention have been described and illustrated above, it should be understood that they are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed is:

1. A method for generating indicia for mail pieces using a mail processing device, the method comprising:
establishing a communication between the mail processing device and a remote data center;
requesting from the data center a meter record, the meter record being associated with a specific customer and being required for a postal security device of the mail processing device to generate and account for indicia;
receiving from the data center the requested meter record;
storing temporarily the meter record in a memory of the postal security device and activating the postal security device to generate indicia;
generating indicia for the mail pieces using the meter record temporarily stored in the memory;
updating the meter record temporarily stored in the memory of the postal security device to reflect the generated indicia for the mail pieces; and
removing the updated meter record from the memory of the postal security device and returning the updated meter record to the data center.

2. The method of claim 1, wherein before the meter record is temporarily stored in the memory of the postal security device, the method further comprises:
validating the meter record received from the data center.

3. The method of claim 2, wherein validating the meter record further comprises:
verifying a register value included in the meter record with a reference value stored in the memory of the postal security device.

4. The method of claim 3, wherein the register value is at least one of an ascending register value or a piece count.

5. The method of claim 2, wherein validating the meter record further comprises:
verifying an upload count value included with the meter record corresponds to an expected value, the upload count value indicating a number of times the meter record has been uploaded to the postal security device from the data center.

6. The method of claim 1, wherein updating the meter record further comprises:
updating at least one register value included in the meter record.

7. The method of claim 6, wherein the at least one register value includes one of an ascending register value, a descending register value, and a piece count value.

8. The method of claim 1, further comprising:
receiving a confirmation of receipt of the updated meter record from the data center.

9. The method of claim 1, wherein removing the updated meter record from the memory of the postal security device further comprises:
deactivating the postal security device from being able to generate any indicia until a subsequent meter record is temporarily stored in the memory.

10. The method of claim 1, wherein receiving the requested meter record further comprises:
receiving an indicia record, the indicia record being associated with the meter record and containing information necessary to create an indicia required by a carrier.

11. A mail processing device comprising:
a postal security device for generating indicia for mail pieces being processed by the mail processing device, the postal security device including a memory;
means for storing a first meter record in the memory and configuring the postal security device with the first meter record, the first meter record being associated with a first customer and being required for the postal security device of the mail processing device to generate and account for indicia for the first customer; and
means for removing the first meter record from the memory, storing a second meter record in the memory and configuring the postal security device with the second meter record, the second meter record being associated with a second customer and being required for the postal security device of the mail processing device to generate and account for indicia for the second customer.

12. The mail processing device of claim 11, wherein the first and second meter records are received from a data center, the device further comprising:
means for validating the first and second meter records received from the data center.

13. The mail processing device of claim 12, wherein the means for validating further comprises:
means for verifying an upload count value included with the meter record corresponds to an expected value, the upload count value indicating a number of times the meter record has been uploaded to the postal security device from the data center
